(19) United States
(12) Patent Application Publication
(10) Pub. No.: US 2025/0157729 A1
(43) Pub. Date: May 15, 2025

(54) METHOD FOR PREPARING HIGH COERCIVITY GRAIN BOUNDARY DIFFUSION NEODYMIUM IRON BORON MAGNET BY HIGH PRESSURE TORSION

(71) Applicant: China University of Metrology, Hangzhou City (CN)

(72) Inventors: Qiong Wu, Hangzhou City (CN); Jiaoli Liang, Hangzhou City (CN); Daode Yu, Hangzhou City (CN); Hangfu Yang, Hangzhou City (CN); Xiukun Hu, Hangzhou City (CN); Hongliang Ge, Hangzhou City (CN)

(21) Appl. No.: 18/915,938

(22) Filed: Oct. 15, 2024

(30) Foreign Application Priority Data
Nov. 14, 2023 (CN) 202311508273.2

(51) Int. Cl. H01F 41/02; H01F 1/057

(52) U.S. Cl. CPC H01F 41/0266; H01F 1/0571

(57) ABSTRACT

A method for preparing a high coercivity grain boundary diffusion neodymium iron boron (NdFeB) magnet by high-pressure torsion, including: Step 1: mixing a NdFeB powder and a heavy rare earth powder, and grinding to achieve uniform mixing to obtain a composite powder; Step 2: pre-pressing the composite powder into a block magnet; Step 3: placing the block magnet in a high-pressure torsion device to cause nucleation, elongation, and refinement to obtain a sheet magnet; and Step 4: performing a diffusion heat treatment on the sheet magnet under a vacuum condition to produce in-situ grain boundary diffusion, and obtaining a high coercivity NdFEB magnet.

### CROSS REFERENCE

The present application claims foreign priority of Chinese Patent Applications No. 202311508273.2, filed on Nov. 14, 2023, the entire contents of which are hereby incorporated by reference.

### TECHNICAL FIELD

The present disclosure relates to the field of magnetic material technologies, and specifically to a method for preparing a high coercivity grain boundary diffusion neodymium iron boron magnet by high-pressure torsion.

### BACKGROUND

In recent years, with the improvement of the magnetic properties of neodymium iron boron (NdFeB) magnets and the reduction of production costs thereof, high-power density permanent magnet motors with the NdFeB magnets as a main material have shown rapid development momentum. They have been widely applied in wind power generation, rail transit, new energy vehicles, etc. As these applications become more in-depth, higher requirements are placed on the comprehensive magnetic properties of the NdFeB magnets. High-performance NdFEB materials have always been the goal of the global magnetic materials industry.

Severe plastic deformation (SPD) is an important method for densification and nanocrystallization of materials. Applying the SPD to Nd—Fe—B alloys can further refine the grain size. Studies have shown that high-pressure torsion (HPT) SPD can induce the formation of α-Fe and Nd₂Fe₁₄B nanocrystals in an amorphous matrix. As the strain increases, the volume fraction of the α-Fe phase in the magnet increases, and the grain size of the α-Fe and Nd₂Fe₁₄B phases decreases to 10-20 nm, thereby achieving higher magnetic properties. This severe plastic thermal deformation technology, which is based on the regulation of stress, strain, and temperature fields, can achieve densification, nanocrystallization, and texturing of amorphous alloy materials.

Grain boundary diffusion technology is a new technology developed in recent years to improve the magnetic properties and reduce the weight of rare earth materials in NdFEB materials. At the same coercivity, the content of heavy rare earth is only 20-30% of that of traditional high coercivity sintered NdFeB permanent magnets, and the remanence is basically unchanged. However, there are limitations on the diffusion efficiency and depth. Regarding this problem, in order to increase the diffusion efficiency and depth of the NdFEB magnets, an in-situ grain boundary diffusion method is applied, which can essentially change the limitations of the depth of diffusion magnets. At present, there are at least two methods for in-situ grain boundary diffusion: one is to introduce heavy rare earth vapor during the air-flow milling of NdFeB powder, such that the surface of the NdFEB particles is coated with a heavy rare earth metal film of a certain thickness, where this layer of heavy rare earth film will diffuse into the 2:14:1 grain during the high-temperature sintering of the magnet, increasing the coercivity of the magnet after forming; the other is to add low melting point alloy powders such as Dy₈₈Mn₁₂, Dy_{71.5}Fe_{28.5}, and Dy_{32.5}Fe₆₂Cu_{5.5} to the NdFeB powder, which is then subjected to subsequent sintering and heat treatment during the pressing and forming process, where the coercivity can be increased by more than 30%.

### SUMMARY OF THE DISCLOSURE

The technical problem to be solved by the present disclosure is to provide a method for preparing a high coercivity grain boundary diffusion neodymium iron boron magnet by high-pressure torsion, which nucleates, elongates and refines the NdFEB magnet through high-pressure torsion, and obtains high coercivity NdFEB magnets by changing the depth of diffusion magnetization and effectively controlling the grain boundary through in-situ grain boundary diffusion.

To achieve the above-mentioned purpose and other related purposes, the technical solution provided by the present disclosure is: a method for preparing a high coercivity grain boundary diffusion neodymium iron boron (NdFeB) magnet by high-pressure torsion, including:
Step 1: mixing a NdFeB powder and a heavy rare earth powder, and grinding to achieve uniform mixing to obtain a composite powder;
Step 2: pre-pressing the composite powder into a block magnet;
Step 3: placing the block magnet in a high-pressure torsion device to cause nucleation, elongation, and refinement to obtain a sheet magnet; and
Step 4: performing a diffusion heat treatment on the sheet magnet under a vacuum condition to produce in-situ grain boundary diffusion, and obtaining a high coercivity NdFeB magnet.

In some embodiments, in step 1, the NdFEB powder is a nano-biphasic NdFeB powder, which is composed of an α-Fe phase and an NdFeB phase; an average particle size of the NdFEB powder is 3-5 μm.

In some embodiments, the heavy rare earth powder is at least one of Dy, Tb, Gd, Pr, Nd, Ce, and La; an average particle size of the heavy rare earth powder is 3-5 μm.

In some embodiments, in step 2, the pre-pressing is carried out with a tablet press and comprises: pressing under a pressure of 15-30 MPa for 1-3 min.

In some embodiments, in step 3, a working condition for a high-pressure torsion treatment is: a pressure is 500-1000 MPa, a number of torsion turns is 10, and a torsion speed is 60°/min.

In some embodiments, the diffusion heat treatment is carried out at a temperature of 600-900° C. for 10-60 minutes.

By virtue of the above technical solutions, the present disclosure has the following advantages over the related art:
1. The high-pressure torsion (HPT) technology proposed in the present disclosure can nucleate, elongate, and refine the NdFEB magnets, and apply SPD to Nd—Fe—B alloys, which can achieve densification, nanocrystallization, and texturing of amorphous alloy materials.
2. The in-situ grain boundary diffusion process proposed in the present disclosure acts on individual micro- and nano-sized NdFeB particles, which can essentially change the limitation of the depth of diffusion magnetization. High coercivity NdFEB magnets can be obtained by changing the depth of diffusion magnetization and effectively controlling the grain boundary.
3. Compared with the traditional diffusion heavy rare earth alloys, the present disclosure has a simple process and is easy to operate, which is conducive to the preparation of high coercivity grain boundary diffusion NdFeB magnets to meet the market demand for permanent magnet materials.

### BRIEF DESCRIPTION OF THE DRAWINGS

FIG. 1 is a demagnetization curve before and after a diffusion heat treatment according to Embodiment 1 of the present disclosure.

FIG. 2 shows a comparison of the demagnetization curve before and after the diffusion heat treatment between the Embodiment 1 and a comparative example.

### DETAILED DESCRIPTION

The following specific embodiments illustrate the implementation of the present disclosure. Those skilled in the art can easily understand other advantages and functions of the present disclosure from the content disclosed in the embodiments.

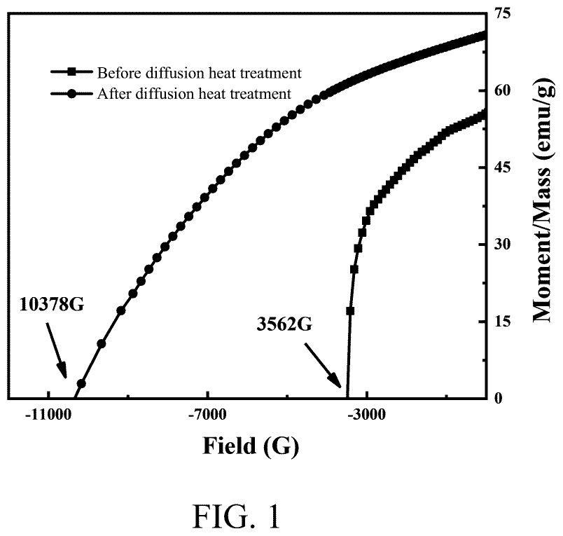

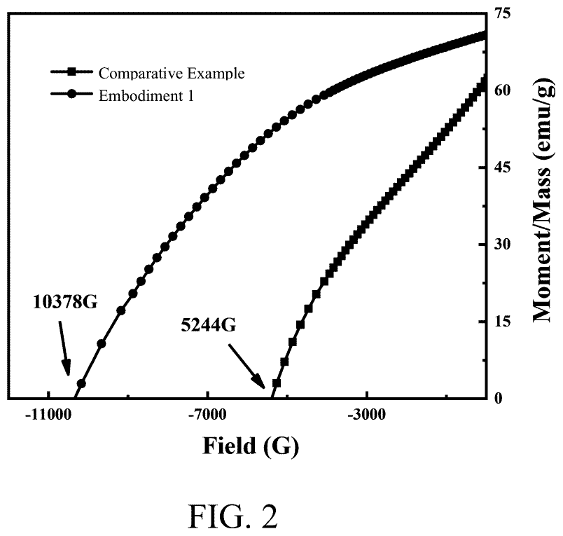

Referring to FIGS. 1 and 2, it should be noted that the structures, proportions, sizes, etc. shown in the figures are only intended to facilitate describing the content disclosed in the specification for the understanding and reading of those skilled in the art, and are not to limit the conditions under which the present disclosure can be implemented. Therefore, they are not technically significant. The following examples are provided to better understand the present disclosure, but not to limit the present disclosure. The experimental methods in the following examples are routine methods unless otherwise specified. The experimental materials adopted in the following examples are all purchased from a conventional biochemical reagent store, unless otherwise specified.

The reagents or materials described in the following examples are all commercially available, unless otherwise specified.

Embodiment 1: A method for preparing a high coercivity grain boundary diffusion neodymium iron boron (NdFeB) magnet by high-pressure torsion, including:
(1) weighing a nano-biphasic NdFeB powder and a heavy rare earth powder (Tb powder) according to a certain ratio, and grinding for not less than 20 minutes to achieve full mixing; where a mass fraction of the Tb powder is 5%, with a size of 300 mesh and a purity of 99.9%.
(2) pressing the mixed powder into a block magnet with a tablet press; where a model of the tablet press is HY-12 infrared tablet press, and the pressure is selected to be 15 MPa for 2 min.
(3) placing the block magnet in a high-pressure torsion device for nucleation, elongation, and refinement, and obtaining a sheet magnet with a thick center and a thin edge; where a model of the high-pressure torsion device is HTP-T6, the pressure is 500 MPa, the number of torsion turns is 1, and the torsion speed is 60°/min.
(4) performing a diffusion heat treatment on the sheet magnet in a vacuum annealing furnace to produce in-situ grain boundary diffusion; where a model of the annealing furnace is RTP-500V rapid annealing furnace, the diffusion heat treatment temperature is selected as 700° C., and the diffusion time is 15 min; a vacuum equipment applied is a ZDF-5227 vacuum gauge, and the vacuum degree is 3×10⁻³ Pa; and obtaining an in-situ grain boundary diffusion NdFEB magnet.

Embodiment 2: A method for preparing a high coercivity grain boundary diffusion neodymium iron boron (NdFeB) magnet by high-pressure torsion, including:
(1) Same as step (1) in Embodiment 1.
(2) Same as step (2) of Embodiment 1.
(3) Same as step (3) of Embodiment 1, except that the high-pressure torsion pressure is selected as 750 MPa, and the number of torsion turns is selected as one turn.
(4) Same as step (4) of Embodiment 1.

Embodiment 3: A method for preparing a high coercivity grain boundary diffusion neodymium iron boron (NdFeB) magnet by high-pressure torsion, including:
(1) Same as step (1) of Embodiment 1.
(2) Same as step (2) of Embodiment 1.
(3) Same as step (3) of Embodiment 1.
(4) performing a diffusion heat treatment on the under a vacuum condition of a magnetic field heat treatment to produce in-situ grain boundary diffusion, where a model of the magnetic field heat treatment is P9060-GP, the diffusion heat treatment temperature is selected as 650° C., the diffusion time is 15 min, and the vacuum degree is <3×10⁻³ P; and obtaining an in-situ grain boundary diffusion NdFEB magnet.

### Comparative Example

The Comparative Example is obtained by replacing the powder weighed in step (1) of Embodiment (1) with the pure nano-biphasic NdFeB powder without the heavy rare earth powder.

The middle part of each of the sheet magnets obtained after high-pressure torsion is taken from the samples prepared by the above-mentioned embodiments and the Comparative Example, thereby obtaining other samples. The coercivity of the samples before and after the diffusion heat treatment is tested by a vibrating sample magnetometer VSM, respectively, and an equipment model of VSM is LakeShore7407 from the United States. The results are shown in Table 1.

TABLE 1

| | | Before diffusion | After diffusion |
|---|---|---|---|
| | | heat treatment | heat treatment |
| No. | Category | H_{cj} (G) | H_{cj} (G) |
| 1 | Embodiment 1 | 3562 | 10378 |
| 2 | Embodiment 2 | 3743 | 11385 |
| 3 | Embodiment 3 | 3665 | 11935 |
| 4 | Comparative Example | 3817 | 5244 |

As can be seen from Table 1, by comparing Embodiment 1 and Embodiment 2, the coercivity can be further increased by changing the pressure of the high-pressure torsion; by comparing Embodiment 1 and Embodiment 3, the coercivity can be further increased by changing the temperature conditions of the diffusion heat treatment; by comparing Embodiments 1, 2 and 3 with the Comparative Example, and in combination with FIG. 2, it can be seen that the in-situ grain boundary diffusion NdFEB magnet has a higher coercivity than the NdFEB magnet without in-situ grain boundary diffusion.

Taking Embodiment 1 as an example, FIG. 1 shows a hysteresis loop in the second quadrant of the Embodiment 1 before and after diffusion heat treatment. It can be seen from FIG. 1 that the coercivity of the magnet after high-pressure torsion and diffusion heat treatment is significantly improved, increasing the coercivity of the diffusion magnet by about 3 times.

In summary, the present disclosure relates to a method for preparing a high coercivity grain boundary diffusion neodymium iron boron (NdFeB) magnet by high-pressure torsion. The grain size is further refined by high-pressure torsion to achieve densification, nanocrystallization, and texturing of the magnet. The depth limitation of the diffusion magnet is then essentially changed by in-situ grain boundary diffusion, and a high coercivity grain boundary diffusion NdFEB magnet is finally obtained, increasing the coercivity of the diffusion magnet by about 2-3 times.

Embodiment 4: A method for preparing a high coercivity grain boundary diffusion neodymium iron boron (NdFeB) magnet by high-pressure torsion, including:
(1) weighing a NdFeB powder and a rare earth powder according to a certain ratio, and grinding for not less than 20 minutes to achieve sufficient mixing;
(2) pre-pressing the mixed powder into a block magnet with a tablet press;
(3) placing the block magnet in a high-pressure torsion device for nucleation, elongation, and refinement, and obtaining a sheet magnet with a thick center and a thin edge;
(4) performing a diffusion heat treatment on the sheet magnet under a vacuum condition to produce in-situ grain boundary diffusion, and obtaining a high coercivity NdFeB magnet by changing a magnet diffusion depth and controlling an effective grain boundary.

The NdFEB powder is a nano-biphasic NdFeB powder, which is composed of an α-Fe phase and a NdFeB phase; the average particle size of the composite powder is about 3-5 μm.

In nanocomposite permanent magnets, the effective range of exchange coupling between the soft and hard magnetic phases in α-Fe is about twice the thickness of the Nd₂Fe₁₄B magnetic domain wall. Exchange coupling can only work when the dimensions of both the soft and hard magnetic phases are below the critical size (about 10 nm). The smaller the grain size, the greater the volume content of the exchange coupling region in the overall material, the more obvious the exchange coupling effect, and the more prominent the remanence enhancement effect. For this reason, the present disclosure adopts nano-biphasic NdFEB powder, which not only reduces costs, but also, due to the complexity of the composition and microstructure, compared to traditional permanent magnet materials, the nano-composite permanent magnet material has the characteristics of a single ferromagnetic phase through the two-phase exchange coupling between the nanocrystals, and at the same time has the high saturation magnetization of the soft magnetic phase and the high coercivity of the hard magnetic phase.

The rare earth powder is at least one of Dy, Tb, Gd, Pr, Nd, Ce, and La. In the present embodiments, Nd powder is specifically selected.

The average particle size of the rare earth powder is about 3-5 μm.

The high-pressure torsion of the magnet is carried out at a high pressure as high as 500 MPa, the number of torsion turns is 10 turns, and the torsion speed is 60°/min.

The temperature of the diffusion heat treatment is 600° C. and the time is 10 min.

Embodiment 5: A method for preparing a high coercivity grain boundary diffusion neodymium iron boron (NdFeB) magnet by high-pressure torsion, including:
Step 1: mixing a NdFeB powder and a heavy rare earth powder, and grinding to achieve uniform mixing to obtain a composite powder;
Step 2: pre-pressing the composite powder into a block magnet;
Step 3: placing the block magnet in a high-pressure torsion device to cause nucleation, elongation, and refinement to obtain a sheet magnet;
Step 4: performing a diffusion heat treatment on the sheet magnet under a vacuum condition to produce in-situ grain boundary diffusion, and obtaining a high coercivity NdFEB magnet.

A preferred technical solution is: in step 1, the NdFEB powder is a nano-biphasic NdFeB powder, which is composed of an α-Fe phase and an NdFEB phase; the average particle size of the composite powder is 3-5 μm.

A preferred technical solution is: the heavy rare earth powder is Ce powder; the average particle size of the heavy rare earth powder is 3-5 μm.

A preferred technical solution is: in step 2, the pressing is carried out with a tablet press, and the specific steps include: pressing under a pressure of 15 MPa for 3 min.

A preferred technical solution is: in step 3, a working condition for the high-pressure torsion of the magnet is: the pressure is 1000 MPa, the number of torsion turns is 10, and the torsion speed is 60°/min.

A preferred technical solution is that the diffusion heat treatment is carried out at a temperature of 900° C. for 10 minutes.

The above is only intended to explain some embodiments of the present disclosure, and not to limit the present disclosure in any way. Therefore, any modification or change to the present disclosure that is made in the same spirit of the present disclosure should still be included in the scope of the present disclosure.

What is claimed is:

1. A method for preparing a high coercivity grain boundary diffusion neodymium iron boron (NdFeB) magnet by high-pressure torsion, comprising:
Step 1: mixing a NdFeB powder and a heavy rare earth powder, and grinding to achieve uniform mixing to obtain a composite powder;
Step 2: pre-pressing the composite powder into a block magnet;
Step 3: placing the block magnet in a high-pressure torsion device to cause nucleation, elongation, and refinement to obtain a sheet magnet; and
Step 4: performing a diffusion heat treatment on the sheet magnet under a vacuum condition to produce in-situ grain boundary diffusion, and obtaining a high coercivity NdFEB magnet.

2. The method according to claim 1, wherein in step 1, the NdFeB powder is a nano-biphasic NdFeB powder, which is composed of an α-Fe phase and an NdFEB phase; an average particle size of the NdFeB powder is 3-5 μm.

3. The method according to claim 1, wherein the heavy rare earth powder is at least one of Dy, Tb, Gd, Pr, Nd, Ce, and La; an average particle size of the heavy rare earth powder is 3-5 μm.

4. The method according to claim 1, wherein in step 2, the pre-pressing is carried out with a tablet press and comprises: pressing under a pressure of 15-30 MPa for 1-3 min.

5. The method according to claim 1, wherein in step 3, a working condition for a high-pressure torsion treatment is: a pressure is 500-1000 MPa, a number of torsion turns is 10, and a torsion speed is 60°/min.

6. The method according to claim 1, wherein the diffusion heat treatment is carried out at a temperature of 600-900° C. for 10-60 minutes.
